(19) United States
(12) Patent Application Publication
(10) Pub. No.: US 2025/0203681 A1
(43) Pub. Date: Jun. 19, 2025

(54) WIRELESS PAIRING METHOD, APPARATUS, AND DEVICE, AND STORAGE MEDIUM

(71) Applicant: GOERTEK TECHNOLOGY CO., LTD., Qingdao (CN)

(72) Inventor: Jiancheng QI, Qingdao (CN)

(21) Appl. No.: 19/070,403

(22) Filed: Mar. 4, 2025

Related U.S. Application Data
(63) Continuation of application No. PCT/CN2023/126134, filed on Oct. 24, 2023.

(30) Foreign Application Priority Data
Oct. 27, 2022 (CN) 202211323452.4

(51) Int. Cl. H04W 76/14; H04W 4/80

(52) U.S. Cl. CPC H04W 76/14; H04W 4/80

(57) ABSTRACT

A method, an apparatus and a wireless pairing device and a storage medium. The wireless pairing method includes: in response to that the wearable device is turned on, detecting a wireless signal of an environment where the wearable device is located; in response to that there is no wireless pairing record, measuring a first distance between the wearable device and a first target AR device by the distance measuring device; in response to that the first distance is less than a preset distance threshold, displaying a preset identification code containing wireless pairing information for the first target AR device to scan; and in response to receiving a pairing request initiated by the first target AR device based on an identification code, establishing a connection with the first target AR device to achieve wireless pairing.

### CROSS-REFERENCE TO RELATED APPLICATIONS

This application is a continuation application of International Application No. PCT/CN2023/126134, filed on Oct. 24, 2023, which claims priority to Chinese Patent Application No. 202211323452.4, filed on Oct. 27, 2022. The disclosures of the above-mentioned applications are incorporated herein by reference in their entireties.

### TECHNICAL FIELD

The present application relates to the technical field of short-range wireless communication connection, and in particular to a wireless pairing method, a wireless pairing apparatus, a wireless pairing device and a storage medium.

### BACKGROUND

At present, when devices with Bluetooth function need to be communicatively connected to each other via Bluetooth, after the user turns on the Bluetooth function on one of the devices, the current device will search for pairable devices in its vicinity. The search results are generally multiple, and include a wide variety of devices, such as watches, mobile phones, Bluetooth headsets, etc. The user views the search result list on the current device and filters out the devices to be paired from the result list. After the user filters, the user clicks on the current device to achieve the Bluetooth connection between the current device and the filtered device, and some even require the user to enter the correct pairing password for successfully pairing.

In the above Bluetooth connection process, the user needs to filter and click from multiple candidate results, and the steps required for the user to operate are numerous, and the efficiency of pairing between devices is not high. That is, there is a problem in the related art that the user's operation is not convenient when performing wireless pairing.

The above content is only used to assist in understanding the technical solution of the present application, and does not mean that the above content is recognized as prior art.

### SUMMARY

The main purpose of the present application is to provide a wireless pairing method, a wireless pairing apparatus, a wireless pairing device and a storage medium, aiming to solve the problem that user's operation is not convenient when performing wireless pairing in the related art.

To achieve the above purpose, the present application provides a wireless pairing method, applied to a wearable device in a wireless pairing system. The wearable device is configured with a preset distance measuring device, the wireless pairing system further includes an augmented reality (AR) device, and the wireless pairing method includes:
in response to that the wearable device is turned on, detecting a wireless signal of an environment where the wearable device is located;
in response to that there is no wireless pairing record, measuring a first distance between the wearable device and a first target AR device by the distance measuring device, wherein the first target AR device is a device with a strongest wireless signal;
in response to that the first distance is less than a preset distance threshold, displaying a preset identification code containing wireless pairing information for the first target AR device to scan; and
in response to receiving a pairing request initiated by the first target AR device based on an identification code, establishing a connection with the first target AR device to achieve wireless pairing.

In an embodiment of the present application, after the step of in response to that the wearable device is turned on, detecting the wireless signal of the environment where the wearable device is located, the wireless pairing method further includes:
in response to that there is a wireless pairing record and the wireless pairing record records at least a detected wireless signal, measuring a second distance between the wearable device and a second target AR device by the distance measuring device, the second target AR device is a device corresponding to a currently detected wireless signal; and
in response to that the second distance is less than the distance threshold, reconnecting with the second target AR device.

In an embodiment of the present application, the wireless pairing method further includes:
in response to that the wearable device is turned on and it is detected that a preset button is triggered, displaying the identification code for a third target AR device to scan; and
in response to receiving the pairing request initiated by the third target AR device based on the identification code, establishing the connection with the third target AR device to achieve wireless pairing.

In an embodiment of the present application, the wearable device is configured with different adjustment gears, and different adjustment gears correspond to different distance thresholds; and the step of in response to that the first distance is less than the preset distance threshold, displaying the preset identification code containing wireless pairing information for the first target AR device to scan includes:
in response to that the first distance is less than a distance threshold corresponding to a current adjustment gear, displaying the identification code for the first target AR device to scan.

In an embodiment of the present application, the wearable device is configured with a display device, and the step of in response to that the first distance is less than the preset distance threshold, displaying the preset identification code containing wireless pairing information for the first target AR device to scan includes:
in response to that the first distance is less than the preset distance threshold, controlling the display device to a maximum screen brightness; and
displaying the identification code for the first target AR device to scan.

In an embodiment of the present application, the identification code includes target service information and target verification information, and the step of in response to receiving the pairing request initiated by the first target AR device based on the identification code, establishing the connection with the first target AR device to achieve wireless pairing includes:
in response to receiving the pairing request initiated by the first target AR device based on the identification code, detecting whether service information corresponding to the pairing request is consistent with the target service information;
in response to that the service information corresponding to the pairing request is consistent with the target service information, establishing a link with the first target AR device;
sending the target verification information to the first target AR device for verification, and in response to receiving information indicating successful verification sent by the first target AR device, determining to conduct wireless pairing; and
in response to receiving information indicating verification failure sent by the first target AR device, sending the target verification information to the first target AR device for secondary verification, until a quantity of verification failures reaches a preset verification quantity threshold, and disconnecting a wireless communication connection between the wearable device and the first target AR device.

In an embodiment of the present application, after the step of in response to receiving the pairing request initiated by the first target AR device based on the identification code, establishing the connection with the first target AR device to achieve wireless pairing, the wireless pairing method further includes:
displaying a wireless pairing result for user confirmation;
obtaining operation information of the user based on the wireless pairing result, wherein the operation information includes change information of the first target AR device and/or information of canceling the pairing; and executing a instruction corresponding to the operation information.

In addition, to achieve the above purpose, the present application also provides a wireless pairing apparatus, including:
a detection module, configured to in response to that the wearable device is turned on, detect a wireless signal of an environment where the wearable device is located;
a first distance measuring module, configured to in response to that there is no wireless pairing record, measure a first distance between the wearable device and a first target AR device by the distance measuring device, wherein the first target AR device is a device with a strongest wireless signal;
a display module, configured to in response to that the first distance is less than a preset distance threshold, display a preset identification code containing wireless pairing information for the first target AR device to scan; and
a pairing module, configured to in response to receiving a pairing request initiated by the first target AR device based on an identification code, establish a connection with the first target AR device to achieve wireless pairing.

In addition, to achieve the above purpose, the present application further provides a wireless pairing device, including: a memory; a processor; and a wireless pairing program stored in the memory and executable on the processor, wherein the wireless pairing program, when executed by the processor, implements the steps of the wireless pairing method as described above.

In addition, to achieve the above purpose, the present application further provides a storage medium, a wireless pairing program is stored in the storage medium, and the wireless pairing program, when executed by a processor, implements the steps of the wireless pairing method as described in the above embodiments.

The present application provides a wireless pairing method, a wireless pairing apparatus, a wireless pairing device and a storage medium. Compared with the problem of low convenience of user operation in the related art when performing wireless pairing, in the present application, after the wearable device is turned on, the wireless signal of an environment where the wearable device is located is detected; when there is no wireless pairing record, the first distance between the wearable device and the first target AR device is measured by the distance measuring device, the first target AR device is the device with the strongest wireless signal; if the first distance is less than the preset distance threshold, the preset identification code containing wireless pairing information is displayed for the first target AR device to scan; when the pairing request initiated by the first target AR device based on the identification code is received, a connection is established with the first target AR device to achieve wireless pairing. In the present application, the first distance between the wearable device and the first target AR device is measured by the distance measuring device, and the identification code for pairing is directly displayed when the first distance is less than the distance threshold. The user only needs to bring the first target AR device close to the wearable device to scan the identification code to achieve wireless pairing. The user is not required to think about how to select the devices to be paired and to avoid the use's click operation. The work of selecting the devices to be paired is replaced by the step of the wearable device detecting the strongest wireless signal, and the user's click operation is replaced by the step of the wearable device displaying the identification code. That is, the steps that require user operation in the wireless pairing process are simplified, and the convenience of user operation is improved during wireless pairing.

### BRIEF DESCRIPTION OF THE DRAWINGS

FIG. 1 is a schematic flowchart of a wireless pairing method according to an embodiment of the present application.

FIG. 2 is a schematic flowchart of a wireless pairing method according to another embodiment of the present application.

FIG. 3 is a schematic flowchart of a wireless pairing method according to another embodiment of the present application.

FIG. 4 is a schematic flowchart of a wireless pairing method according to another embodiment of the present application.

FIG. 5 is a schematic flowchart of a wireless pairing method according to another embodiment of the present application.

FIG. 6 is a schematic view of a wireless pairing device corresponding to a wireless pairing method according to an embodiment of the present application.

FIG. 7 is a schematic structure view of a device in a hardware operating environment involved in a wireless pairing method according to an embodiment of the present application.

The realization of the objective, functional characteristics, and advantages of the present application are further described with reference to the accompanying drawings and in conjunction with the embodiments.

### DETAILED DESCRIPTION OF THE EMBODIMENTS

Here, exemplary embodiments will be described in detail, and examples thereof are shown in the accompanying drawings. When the following description refers to the drawings, unless otherwise indicated, the same numbers in different drawings represent the same or similar elements. The embodiments described in the following exemplary embodiments do not represent all embodiments consistent with the present application. Instead, they are only examples of devices and methods consistent with some aspects of the present application as detailed in the attached claims.

It should be noted that in the present application, the terms “include”, “comprise” or any other variant thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “comprises a . . . ” does not exclude the existence of other identical elements in the process, method, article or device including the element. In addition, components, features, and elements with the same name in different embodiments of the present application may have the same meaning or different meanings, and their specific meanings need to be determined by their explanation in the specific embodiment or further combined with the context of the specific embodiment.

It should be understood that, although the terms first, second, third, etc. may be used to describe various information in this article, these information should not be limited to these terms. These terms are only used to distinguish the same type of information from each other. For example, without departing from the scope of this article, the first information may also be referred to as the second information, and similarly, the second information may also be referred to as the first information. Depending on the context, the word “if” as used herein can be interpreted as “at the time of” or “when” or “in response to determination”. Furthermore, as used in this article, the singular forms “one”, “one” and “the” are intended to also include plural forms, unless there is an opposite indication in the context. It should be further understood that the terms “comprising” and “including” indicate that there are the described features, steps, operations, elements, components, projects, kinds, and/or groups, but do not exclude the existence, occurrence or addition of one or more other features, steps, operations, elements, components, projects, kinds, and/or groups. The terms “or”, “and/or”, “including at least one of the following” etc. used in the present application can be interpreted as inclusive, or mean any one or any combination. For example, “including at least one of the following: A, B, C” means “any of the following: A; B; C; A and B; A and C; B and C; A and B and C”, and for another example, “A, B or C” or “A, B and/or C” means “any of the following: A; B; C; A and B; A and C; B and C; A and B and C”. Exceptions to this definition only occur when the combination of elements, functions, steps or operations is inherently mutually exclusive in some way.

It should be understood that although the steps in the flowcharts in the embodiments of the present application are displayed in sequence as indicated by the arrows, these steps are not necessarily executed in the order indicated by the arrows. Unless otherwise specified in this document, there is no strict order restriction for the execution of these steps, and they can be executed in other orders. Moreover, at least part of the steps in the figure may include multiple sub-steps or multiple stages, which are not necessarily executed at the same time, but can be executed at different times, and their execution order is not necessarily sequential, but can be executed in turn or alternating with other steps or at least part of the sub-steps or stages of other steps.

Depending on the context, the words “if” and “if” as used herein may be interpreted as “at the time of” or “when” or “in response to determination” or “in response to detection”. Similarly, depending on the context, the phrases “if it is determined” or “if (the stated condition or event) is detected” may be interpreted as “when it is determined” or “in response to determination” or “when (the stated condition or event) is detected” or “in response to detection (the stated condition or event)”.

It should be noted that, in the present application, step codes such as S10 and S20 are used for the purpose of more clearly and concisely describing the corresponding content, and do not constitute a substantial restriction on the order. When implementing the specific implementation, those skilled in the art may execute S20 first and then S10, etc., but these should be within the scope of protection of the present application.

It should be understood that the specific embodiments described herein are only used to explain the present application and are not used to limit the present application.

In the subsequent description, the use of suffixes such as “module”, “component” or “unit” used to represent elements is only for the purpose of facilitating the description of the present application, and has no specific meaning in itself. Therefore, “module”, “component” or “unit” can be used in a mixed manner.

In order to make the above-mentioned purposes, features and advantages of the present application more obvious and easy to understand, the technical solutions in the embodiments of the present application will be clearly and completely described below in conjunction with the drawings in the embodiments of the present application. Obviously, the described embodiments are only part of the embodiments of the present application, not all of them. Based on the embodiments of the present application, all other embodiments obtained by those skilled in the art in this field without creative work belong to the scope of protection of the present application.

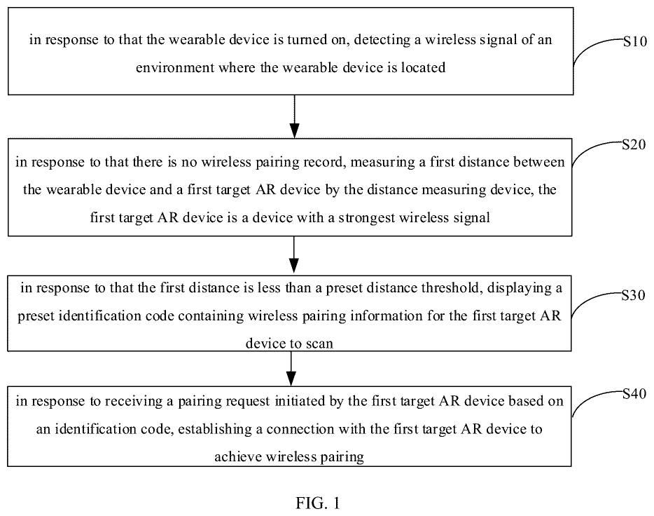

The embodiment of the present application provides a wireless pairing method. As shown in FIG. 1, the wireless pairing method is applied to a wearable device in a wireless pairing system, the wearable device is configured with a preset distance measuring device, the wireless pairing system also includes an augmented reality (AR) device, and the wireless pairing method includes:
Step S10, in response to that the wearable device is turned on, detecting a wireless signal of an environment where the wearable device is located;
Step S20, in response to that there is no wireless pairing record, measuring a first distance between the wearable device and a first target AR device by the distance measuring device, the first target AR device is a device with a strongest wireless signal;
Step S30, in response to that the first distance is less than a preset distance threshold, displaying a preset identification code containing wireless pairing information for the first target AR device to scan; and
Step S40, in response to receiving a pairing request initiated by the first target AR device based on an identification code, establishing a connection with the first target AR device to achieve wireless pairing.

The application background of this embodiment is that at present, when wireless communicatively connection is required between devices, after the user turns on the wireless connection function on one of the devices, the current device will search for pairable devices within its vicinity. The search results are generally multiple, and include a wide variety of devices, such as watches, mobile phones, Bluetooth headsets, etc. The user views the search result list on the current device and filters out the devices to be paired from the result list. After the user filters, the user clicks on the current device to achieve wireless connection between the current device and the filtered device. Some even require the user to enter the correct pairing password for successfully pair. During the wireless connection process, the user needs to filter and click from multiple candidate results, and the user needs to operate many steps. The efficiency of pairing between devices is not high. That is, there is a problem in the related art that the user's operation is not convenient when performing wireless pairing.

The embodiment aims to improve the convenience of user operation when performing wireless pairing.

As an example, the wearable device can be a wearable device with display function such as a smart watch and a smart bracelet.

As an example, the identification code can be a QR code or a barcode, which is not specifically limited here.

In the embodiment, the AR device refers to a device that uses AR technology to integrate virtual information with the real world.

As an example, the first target AR device can be an AR device capable of scanning the identification code such as AR glasses and AR helmets.

In the embodiment, wireless signals can be divided into short-range wireless signals and long-range wireless signals based on the transmission first distance. Short-range wireless signals include Bluetooth signals, Near Field Communication (NFC) signals and Wireless Fidelity (Wi-Fi) signals. Long-range wireless signals include General Packet Radio Service (GPRS) signals.

As an example, the distance measuring device can be a device including an Ultra Wide Band (UWB) module.

As an example, the wearable device is a smart watch, and the wireless signal is a Bluetooth signal. When the user turns on the smart watch, the smart watch detects the Bluetooth signal of the environment where the smart watch is located. The smart watch may detect multiple Bluetooth signals, and the signal strength of different Bluetooth signals is different. Since the closer the first distance between the two devices, the stronger the Bluetooth signal strength detected from the other device, then among the detected Bluetooth signals, the device with the strongest Bluetooth signal is the first target AR device.

As an example, if the smart watch has not been paired with other devices, there is no wireless pairing record in the smart watch. When there is no wireless pairing record, the first distance between the smart watch and the first target AR device is measured by the distance measuring device. Since it is based on Bluetooth signals, the corresponding first distance can be calculated according to the algorithm, but the accuracy of the first distance is only at the meter level. The first distance determined based on Bluetooth signals is relatively rough. In the embodiment, a more accurate distance measurement tool, such as a UWB device, is used. The first distance between the wearable device and the first target AR device is measured by the UWB device. If the first distance is less than the preset distance threshold S, the preset identification code containing wireless pairing information is displayed for the first target AR device to scan.

As an example, if the first distance is less than the distance threshold S, a QR code is displayed for the AR glasses to scan. The distance threshold allows the two parties to be wirelessly connected to pair at a close distance to ensure that the AR glasses can scan the QR code. The user only needs to bring the AR glasses close to the smart watch and align the AR glasses with the smart watch to make the AR glasses scan the QR code. The AR glasses initiate a pairing request to the smart watch based on the QR code, and when the smart watch receives the pairing request, it establishes a communication connection with the AR glasses to achieve wireless pairing.

The specific steps are as follows:

Step S10, in response to that the wearable device is turned on, detecting a wireless signal of an environment where the wearable device is located.

As an example, the user presses the power button of the smart watch to turn on the smart watch. After the smart watch is turned on, the Bluetooth signal of the environment where the smart watch is located is detected to obtain a Bluetooth signal list, the Bluetooth signal list includes Bluetooth signal 1 of device 1, Bluetooth signal 2 of device 2, and Bluetooth signal 3 of device 3, and the strength of Bluetooth signal 3 is the strongest.

Step S20, in response to that there is no wireless pairing record, measuring a first distance between the wearable device and a first target AR device by the distance measuring device, the first target AR device is a device with a strongest wireless signal.

In the embodiment, the strength of Bluetooth signal 3 is the strongest, and it is determined that the wearable device is closest to device 3, and device 3 is the first target AR device.

In the embodiment, when the smart watch has not been wirelessly paired, that is, when there is no wireless pairing record, the first distance between the smart watch and device 3 is measured by the UWB device. In the embodiment, the UWB device is used for distance measurement instead of calculating the distance based on the Bluetooth signal. The reason is that the distance measurement accuracy of the UWB device is higher, and the distance measurement accuracy can even reach the centimeter level.

Step S30, in response to that the first distance is less than a preset distance threshold, displaying a preset identification code containing wireless pairing information for the first target AR device to scan.

As an example, the preset distance threshold S is 30 cm, then when the first distance between the wearable device and the first target AR device is 30 cm, it is considered that it is close at this time, and the QR code can be displayed and scanned. The QR code contains Bluetooth pairing information.

If the first distance is less than 30 cm, the QR code is displayed, and the user aims the camera in the AR glasses at the QR code. After the AR glasses scan the QR code, a pairing request is initiated to the smart watch based on the QR code.

As an example, the smart watch is configured with different adjustment gears, and different adjustment gears correspond to different distance thresholds. For example, the distance threshold corresponding to gear 1 is 30 cm, and the distance threshold corresponding to gear 2 is 15 cm. If the current adjustment gear is gear 2, and the first distance is less than 15 cm, the QR code is displayed for the AR glasses to scan.

As an example, the wearable device is configured with a display device, such as a display screen. Since the brightness of the display screen itself affects the scanning effect, if the screen brightness is not enough, there is a situation where the scanning is unsuccessful. Then when displaying through the display screen, the brightness of the display screen is controlled to the maximum brightness.

Step S40, in response to receiving a pairing request initiated by the first target AR device based on an identification code, establishing a connection with the first target AR device to achieve wireless pairing.

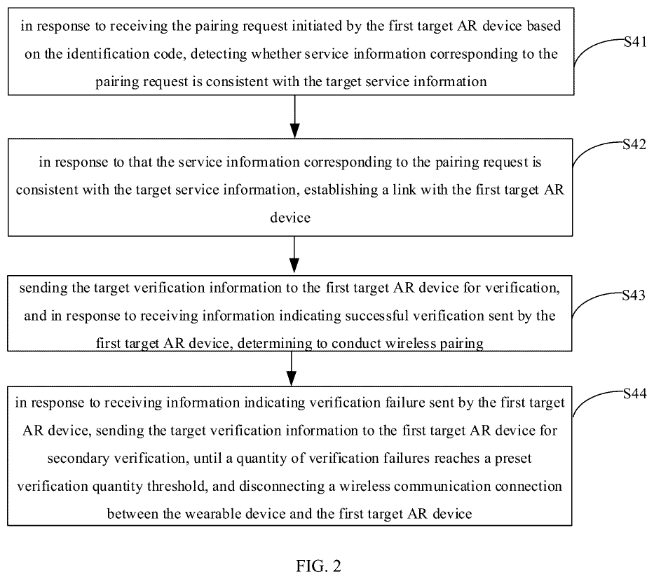

As an example, the identification code includes target service information and target verification information. As shown in FIG. 2, step S40, in response to receiving a pairing request initiated by the first target AR device based on an identification code, establishing a connection with the first target AR device to achieve wireless pairing, includes the steps S41-S44:

Step S41, in response to receiving the pairing request initiated by the first target AR device based on the identification code, detecting whether service information corresponding to the pairing request is consistent with the target service information.

In the embodiment, according to the pairing request, the service information corresponding to the pairing request is determined, and only when the requested service information is consistent with the target service information, the link is established.

Step S42, in response to that the service information corresponding to the pairing request is consistent with the target service information, establishing a link with the first target AR device.

As an example, if the service information corresponding to the pairing request is consistent with the target service information, establish a Bluetooth Low Energy (BLE) link with the AR glasses.

Step S43, sending the target verification information to the first target AR device for verification, and in response to receiving information indicating successful verification sent by the first target AR device, determining to conduct wireless pairing.

As an example, after the BLE link is established, the target Bluetooth verification information is sent to the AR glasses for verification, and when the information indicating successful verification sent by the AR glasses is received, the wireless pairing is determined to be conduct.

Step S44, in response to receiving information indicating verification failure sent by the first target AR device, sending the target verification information to the first target AR device for secondary verification, until a quantity of verification failures reaches a preset verification quantity threshold, and disconnecting a wireless communication connection between the wearable device and the first target AR device.

As an example, when the information indicating verification failure sent by the AR glasses is received, the target Bluetooth verification information is sent to the AR glasses for secondary verification, if the information indicating verification failure is received, the wearable device continues to send the target verification information until the quantity of verification failures reaches the preset 5 times. Then it is determined that wireless pairing cannot be achieved, and the wearable device disconnects the wireless connection with the AR glasses.

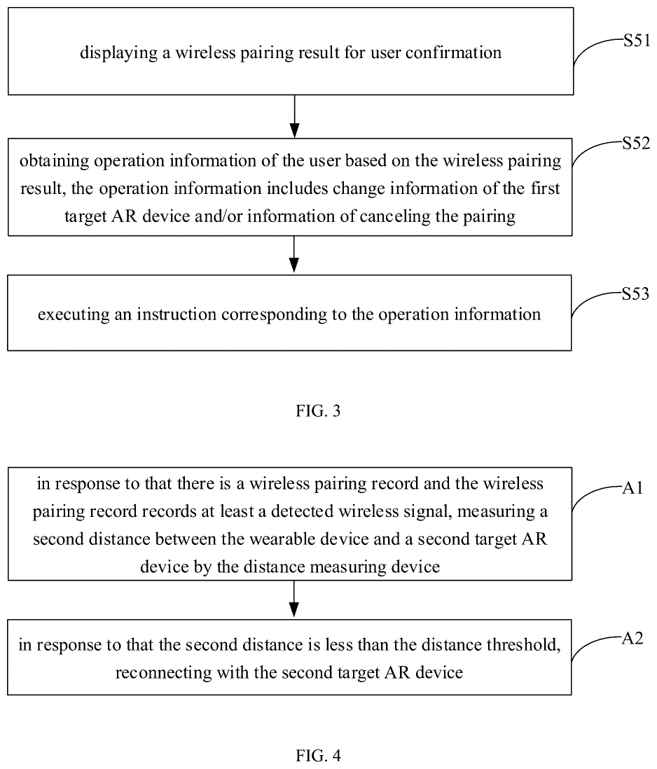

As an example, as shown in FIG. 3, after the step S40, in response to receiving a pairing request initiated by the first target AR device based on an identification code, establishing a connection with the first target AR device to achieve wireless pairing, the method further including the steps S51-S53:

Step S51, displaying a wireless pairing result for user confirmation.

As an example, after successful wireless pairing, the wearable device displays the current wireless pairing result to the user for user confirmation. The pairing result may be the Bluetooth name and Bluetooth address of the device paired with the wearable device.

Step S52, obtaining operation information of the user based on the wireless pairing result, the operation information includes change information of the first target AR device and/or information of canceling the pairing.

As an example, after viewing the pairing result, the user wants to change the device paired with the wearable device from device 1 to device 2, and the user performs the operation of changing the device paired with the wearable device on the display interface of the smart watch.

As an example, after viewing the pairing result, the user temporarily cancels the pairing, and the cancellation pairing operation is performed on the display interface of the smart watch.

As an example, the use's operation information includes the change information and/or the cancellation pairing information.

Step S53, executing an instruction corresponding to the operation information.

As an example, if the user's change information is obtained, the instruction corresponding to the change information is executed based on the change information.

The present application provides a method, an apparatus and a wireless pairing device and a storage medium. Compared with the problem of low convenience of user operation in the related art when performing wireless pairing, in the present application, after the wearable device is turned on, the wireless signal of an environment where the wearable device is located is detected; when there is no wireless pairing record, the first distance between the wearable device and the first target AR device is measured by the distance measuring device, the first target AR device is the device with the strongest wireless signal; if the first distance is less than the preset distance threshold, the preset identification code containing wireless pairing information is displayed for the first target AR device to scan; when the pairing request initiated by the first target AR device based on the identification code is received, a connection is established with the first target AR device to achieve wireless pairing. In the present application, the first distance between the wearable device and the first target AR device is measured by the distance measuring device, and the identification code for pairing is directly displayed when the first distance is less than the distance threshold. The user only needs to bring the first target AR device close to the wearable device to scan the identification code to achieve wireless pairing. The user is not required to think about how to select the devices to be paired and to avoid the user's click operation. The work of selecting the devices to be paired is replaced by the step of the wearable device detecting the strongest wireless signal, and the user's click operation is replaced by the step of the wearable device displaying the identification code. That is, the steps that require user operation in the wireless pairing process are simplified, and the convenience of user operation is improved during wireless pairing.

Further, based on the above embodiment of the present application, another embodiment of the present application is provided. In the embodiment, as shown in FIG. 4, after the step S10, in response to that the wearable device is turned on, detecting a wireless signal of an environment where the wearable device is located, the wireless pairing method further includes steps A1-A2:

Step A1, in response to that there is a wireless pairing record and the wireless pairing record records at least a detected wireless signal, measuring a second distance between the wearable device and a second target AR device by the distance measuring device, the second target AR device is a device corresponding to a currently detected wireless signal.

As an example, if the smart watch has been paired, there is a pairing record. After the wireless signal of an environment where the wearable device is located is detected after the power is turned on, if the detected wireless signal has been paired before, that is, the currently detected wireless signal is recorded in the wireless pairing record, that is, the same second target AR device is re-paired.

As an example, when re-pairing with the same second target AR device, it is only necessary that the second distance between the wearable device and the second target AR device is less than the preset distance threshold. If the second distance is less than the distance threshold, wireless pairing is performed directly without the step of re-scanning the identification code.

As an example, the device corresponding to the currently detected wireless signal is used as the second target AR device.

As an example, when re-pairing with the same second target AR device, the second distance between the wearable device and the second target AR device is measured by the UWB device.

Step A2, in response to that the second distance is less than the distance threshold, reconnecting with the second target AR device.

As an example, if the second distance is less than the distance threshold, the wearable device re-establishes a wireless connection with the second target AR device directly.

In the embodiment, when re-pairing with the same second target AR device, if the second distance between the wearable device and the second target AR device is less than the preset distance threshold, the wearable device establishes a wireless re-connection directly without re-scanning the identification code. The method simplifies the steps for user's to scan codes. The wearable device reconnects with the second target AR device directly based on the second distance. On the basis of ensuring the pairing accuracy, the user's operation process is simplified. That is, the convenience of user operation during wireless pairing is further improved.

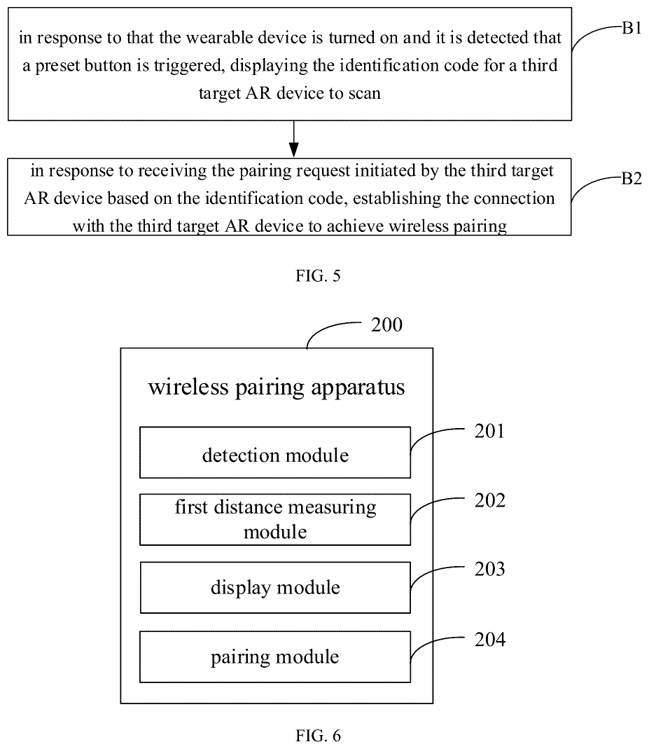

Further, based on all the above embodiments, another embodiment of the present application is provided. In the embodiment, as shown in FIG. 5, the wireless pairing method further includes steps B1-B2:

Step B1, in response to that the wearable device is turned on and it is detected that a preset button is triggered, displaying the identification code for a third target AR device to scan; and

Step B2, in response to receiving the pairing request initiated by the third target AR device based on the identification code, establishing the connection with the third target AR device to achieve wireless pairing.

In the embodiment, the preset button is a trigger switch for displaying the identification code. When the button is pressed by the user, the identification code is directly displayed.

As an example, if the third target AR device needs to be paired, the user only needs to press the preset button to trigger the display of the identification code for the third target AR device to scan and pair.

As an example, if another AR device (device to be paired) needs to be paired, and there is a pairing record in the wearable device, but there is no device to be paired in the pairing record. Then the user can trigger the button to directly display the QR code for the device to be paired to scan and achieve wireless pairing.

As an example, after the wearable device is turned on, if it is detected that a button is pressed, a QR code is displayed for the third target AR device to scan, the third target AR device is the current device to be paired. When a pairing request initiated by the third target AR device based on the identification code is received, a connection is established with the third target AR device to achieve wireless pairing.

As an example, the wearable device can not only complete pairing with another AR device by displaying an identification code when a button is pressed, but also complete pairing with another AR device by comparing the distance obtained through a distance measuring device with the distance threshold. If the distance between the wearable device and another AR device is less than the preset distance threshold, the wearable device displays a QR code on the display screen for the other AR device to scan, and after the other AR device scans, pairing begins.

In the embodiment, by presetting the button, when the button is pressed, the identification code is directly displayed for the device to be paired to scan, the device to be paired can be another AR device. Then wireless pairing can be performed for different AR devices, and the user operation process is simple during pairing. The user only needs to press the preset button on the wearable device to trigger the pairing. That is, the convenience of user operation during wireless pairing is further improved.

Further, based on all the above embodiments, another embodiment of the present application is provided. In the embodiment, as shown in FIG. 6, a wireless pairing apparatus is provided, and the wireless pairing apparatus 200 includes: a detection module 201, a first distance measuring module 202, a display module 203, and a pairing module 204.

The detection module 201 is configured to in response to that the wearable device is turned on, detect a wireless signal of an environment where the wearable device is located.

The first distance measuring module 202 is configured to in response to that there is no wireless pairing record, measure a first distance between the wearable device and a first target AR device by the distance measuring device, the first target AR device is a device with a strongest wireless signal.

The display module 203 is configured to in response to that the first distance is less than a preset distance threshold, display a preset identification code containing wireless pairing information for the first target AR device to scan.

The pairing module 204 is configured to in response to receiving a pairing request initiated by the first target AR device based on an identification code, establish a connection with the first target AR device to achieve wireless pairing.

In a possible implementation of the present application, after the step of in response to that the wearable device is turned on, detecting a wireless signal of an environment where the wearable device is located, the wireless pairing apparatus includes:
a first distance measurement module, which is configured to in response to that there is a wireless pairing record and the wireless pairing record records at least a detected wireless signal, measure a second distance between the wearable device and a second target AR device by the distance measuring device, the second target AR device is a device corresponding to a currently detected wireless signal; and
a re-connection module, which is configured to in response to that the second distance is less than the distance threshold, reconnect with the second target AR device.

In a possible implementation of the present application, the wireless pairing apparatus also includes:
a first display module, which is configured to in response to that the wearable device is turned on and it is detected that a preset button is triggered, display the identification code for a third target AR device to scan; and in response to receiving the pairing request initiated by the third target AR device based on the identification code, establish the connection with the third target AR device to achieve wireless pairing.

In a possible implementation of the present application, the wearable device is configured with different adjustment gears, and different adjustment gears correspond to different distance thresholds. Regarding the step of in response to that the first distance is less than the preset distance threshold, displaying the preset identification code containing wireless pairing information for the first target AR device to scan, the wireless pairing apparatus includes:
a second display module, which is configured to in response to that the first distance is less than a distance threshold corresponding to a current adjustment gear, display the identification code for the first target AR device to scan.

In a possible implementation of the present application, the wearable device is configured with a display device. Regarding the step of in response to that the first distance is less than the preset distance threshold, displaying the preset identification code containing wireless pairing information for the first target AR device to scan, the wireless pairing apparatus includes:
a control module, which is configured to in response to that the first distance is less than the preset distance threshold, control the display device to a maximum screen brightness; and
a third display module, which is configured to display the identification code for the first target AR device to scan.

In a possible implementation of the present application, the identification code includes target service information and target verification information. Regarding the step of in response to receiving the pairing request initiated by the first target AR device based on the identification code, establishing the connection with the first target AR device to achieve wireless pairing, the wireless pairing apparatus includes:
a first detection module, which is configured to in response to receiving the pairing request initiated by the first target AR device based on the identification code, detect whether service information corresponding to the pairing request is consistent with the target service information;
a link establishment module, which is configured to in response to that the service information corresponding to the pairing request is consistent with the target service information, establish a link with the first target AR device;
a first pairing module, which is configured to send the target verification information to the first target AR device for verification, and in response to receiving information indicating successful verification sent by the first target AR device, determine to conduct wireless pairing; and

a second pairing module, which is configured to in response to receiving information indicating verification failure sent by the first target AR device, send the target verification information to the first target AR device for secondary verification, until a quantity of verification failures reaches a preset verification quantity threshold, and disconnect a wireless communication connection between the wearable device and the first target AR device.

In a possible implementation of the present application, after the step of in response to receiving the pairing request initiated by the first target AR device based on the identification code, establishing the connection with the first target AR device to achieve wireless pairing, the wireless pairing apparatus includes:
a fourth display module, which is configured to display a wireless pairing result for user confirmation;
an acquisition module, which is configured to obtain operation information of the user based on the wireless pairing result, the operation information includes change information of the first target AR device and/or information of canceling the pairing; and
an execution module, which is configured to execute a instruction corresponding to the operation information.

The specific implementation of the wireless pairing apparatus of the present application is basically the same as the above-mentioned embodiments of the wireless pairing method, and will not be repeated here.

Further, based on all the above embodiments, another embodiment of the present application is provided. In the embodiment, a wireless pairing device is provided. The wireless pairing device is a physical node device. The wireless pairing device includes: a memory, a processor, and a wireless pairing program stored in the memory. The memory is used to store the wireless pairing program; the processor is used to execute the wireless pairing program to implement the steps of the wireless pairing method in the above embodiment.

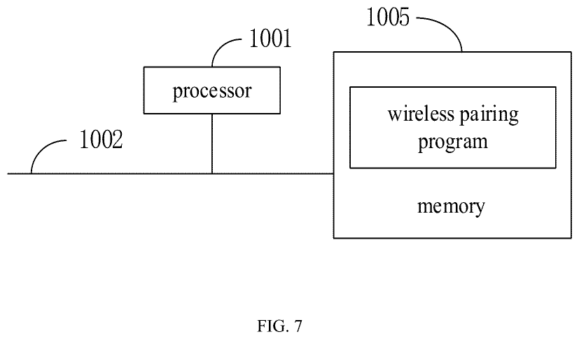

As shown in FIG. 7, FIG. 7 is a schematic view of a wireless pairing device corresponding to a wireless pairing method according to an embodiment of the present application.

As shown in FIG. 7, the wireless pairing device may include: a processor 1001, such as a CPU, a memory 1005, and a communication bus 1002. The communication bus 1002 is used to realize the connection communication between the processor 1001 and the memory 1005. The memory 1005 stores a wireless pairing program. The memory 1005 can be a high-speed RAM memory or a stable memory (non-volatile memory), such as a disk memory. The memory 1005 can also be a storage device independent of the aforementioned processor 1001.

In a possible implementation of the present application, the wireless pairing device may also include a network interface, an audio circuit, a display, a connecting line, a sensor, an input module, etc. The network interface may optionally include a standard wired interface, a wireless interface (such as a WI-FI interface, a Bluetooth interface), and the input module may optionally include a keyboard, a system soft keyboard, a voice input, a wireless receiving input, etc.

Those skilled in the art can understand that the structure of the wireless pairing device does not constitute a limitation on the wireless pairing device, and may include more or fewer components than shown in the figure, or a combination of certain components, or different component arrangements.

A memory as a computer storage medium may include an operating system, an information exchange module, and a wireless pairing program. The operating system is a program that manages and controls the hardware and software resources of the wireless pairing device, and supports the operation of the wireless pairing program and other software and/or programs. The information exchange module is used to realize communication between the components inside the memory, and communication with other hardware and software in the management system.

In the wireless pairing device, the processor is used to execute the wireless pairing program stored in the memory to implement the above-mentioned the steps of the wireless pairing method.

The specific implementation of the wireless pairing device of the present application is basically the same as the above-mentioned embodiments of the wireless pairing method, and will not be repeated here.

The embodiment of the present application provides a storage medium, and the storage medium stores one or more programs for wireless pairing, and the one or more programs for wireless pairing can also be executed by one or more processors to implement the steps of the wireless pairing method in the above embodiment.

The specific implementation of the storage medium of the present application is basically the same as the embodiments of the wireless pairing method described above, and will not be repeated here.

It should be noted that, in this article, the terms “include”, “comprise” or any other variants thereof are intended to cover non-exclusive inclusion, so that a process, method, article or system including a series of elements includes not only those elements, but also other elements not explicitly listed, or also includes elements inherent to such process, method, article or system. In the absence of further restrictions, the elements defined by the sentence “include one . . . ” do not exclude the existence of other identical elements in the process, method, article or system including the element.

The serial numbers of the embodiments of the present application described above are only for description and do not represent the advantages and disadvantages of the embodiments.

Through the description of the above implementation, those skilled in the art can clearly understand that the above embodiment method can be implemented by means of software plus the necessary general hardware platform, of course, it can also be implemented by hardware, but in many cases the former is a better implementation. Based on this understanding, the technical solution of the present application can essentially or the part that contributes to the prior art can be embodied in the form of a software product. The computer software product is stored in a storage medium (such as ROM or RAM, disk, or CD) as described above, and includes a number of instructions for enabling a terminal device (which can be a mobile phone, computer, server, air conditioner, or network device, etc.) to execute the methods described in the various embodiments of the present application.

The above are only some embodiments of the present application, and do not limit the scope of the present application thereto. Under the inventive concept of the present application, equivalent structural transformations made according to the description and drawings of the present application, or direct/indirect application in other related technical fields, are included in the scope of the present application.

What is claimed is:

1. A wireless pairing method, applied to a wearable device in a wireless pairing system, wherein the wearable device is configured with a preset distance measuring device, the wireless pairing system further comprises an augmented reality (AR) device, and the wireless pairing method comprises:
in response to that the wearable device is turned on, detecting a wireless signal of an environment where the wearable device is located;
in response to that there is no wireless pairing record, measuring a first distance between the wearable device and a first target AR device by the distance measuring device, wherein the first target AR device is a device with a strongest wireless signal;
in response to that the first distance is less than a preset distance threshold, displaying a preset identification code containing wireless pairing information for the first target AR device to scan; and
in response to receiving a pairing request initiated by the first target AR device based on an identification code, establishing a connection with the first target AR device to achieve wireless pairing.

2. The wireless pairing method according to claim 1, wherein after the step of in response to that the wearable device is turned on, detecting the wireless signal of the environment where the wearable device is located, the wireless pairing method further comprises:
in response to that there is a wireless pairing record and the wireless pairing record records at least a detected wireless signal, measuring a second distance between the wearable device and a second target AR device by the distance measuring device, wherein the second target AR device is a device corresponding to a currently detected wireless signal; and
in response to that the second distance is less than the distance threshold, reconnecting with the second target AR device.

3. The wireless pairing method according to claim 1, further comprising:
in response to that the wearable device is turned on and it is detected that a preset button is triggered, displaying the identification code for a third target AR device to scan; and
in response to receiving the pairing request initiated by the third target AR device based on the identification code, establishing the connection with the third target AR device to achieve wireless pairing.

4. The wireless pairing method according to claim 1, wherein the wearable device is configured with different adjustment gears, and different adjustment gears correspond to different distance thresholds; and the step of in response to that the first distance is less than the preset distance threshold, displaying the preset identification code containing wireless pairing information for the first target AR device to scan comprises:
in response to that the first distance is less than a distance threshold corresponding to a current adjustment gear, displaying the identification code for the first target AR device to scan.

5. The wireless pairing method according to claim 1, wherein the wearable device is configured with a display device, and the step of in response to that the first distance is less than the preset distance threshold, displaying the preset identification code containing wireless pairing information for the first target AR device to scan comprises:
in response to that the first distance is less than the preset distance threshold, controlling the display device to a maximum screen brightness; and
displaying the identification code for the first target AR device to scan.

6. The wireless pairing method according to claim 1, wherein the identification code comprises target service information and target verification information, and the step of in response to receiving the pairing request initiated by the first target AR device based on the identification code, establishing the connection with the first target AR device to achieve wireless pairing comprises:
in response to receiving the pairing request initiated by the first target AR device based on the identification code, detecting whether service information corresponding to the pairing request is consistent with the target service information;
in response to that the service information corresponding to the pairing request is consistent with the target service information, establishing a link with the first target AR device;
sending the target verification information to the first target AR device for verification, and in response to receiving information indicating successful verification sent by the first target AR device, determining to conduct wireless pairing; and
in response to receiving information indicating verification failure sent by the first target AR device, sending the target verification information to the first target AR device for secondary verification, until a quantity of verification failures reaches a preset verification quantity threshold, and disconnecting a wireless communication connection between the wearable device and the first target AR device.

7. The wireless pairing method according to claim 1, wherein after the step of in response to receiving the pairing request initiated by the first target AR device based on the identification code, establishing the connection with the first target AR device to achieve wireless pairing, the wireless pairing method further comprises:
displaying a wireless pairing result for user confirmation;
obtaining operation information of the user based on the wireless pairing result, wherein the operation information comprises change information of the first target AR device and/or information of canceling the pairing; and
executing a instruction corresponding to the operation information.

8. A wireless pairing apparatus, comprising:
a detection module, configured to in response to that the wearable device is turned on, detect a wireless signal of an environment where the wearable device is located;
a first distance measuring module, configured to in response to that there is no wireless pairing record, measure a first distance between the wearable device and a first target AR device by the distance measuring device, wherein the first target AR device is a device with a strongest wireless signal;
a display module, configured to in response to that the first distance is less than a preset distance threshold, display a preset identification code containing wireless pairing information for the first target AR device to scan; and
a pairing module, configured to in response to receiving a pairing request initiated by the first target AR device based on an identification code, establish a connection with the first target AR device to achieve wireless pairing.

9. A wireless pairing device, comprising:
a memory;
a processor; and
a wireless pairing program stored in the memory and executable on the processor,
wherein the wireless pairing program, when executed by the processor, implements the steps of the wireless pairing method according to claim 1.

10. A non-transitory computer readable storage medium, wherein a wireless pairing program is stored in the non-transitory computer readable storage medium, and the wireless pairing program, when executed by a processor, implements the steps of the wireless pairing method according to claim 1.
